(19) United States
(12) Patent Application Publication
(10) Pub. No.: US 2018/0340650 A1
(43) Pub. Date: Nov. 29, 2018

(54) INSTALLATION DEVICE

(71) Applicant: PROFIL Verbindungstechnik GmbH & Co. KG, Friedrichsdorf (DE)

(72) Inventor: Andreas Lembach, Darmstadt (DE)

(21) Appl. No.: 15/991,415

(22) Filed: May 29, 2018

(30) Foreign Application Priority Data
May 29, 2017 (DE) 102017111669.9

(51) Int. Cl. F16M 13/02; F16B 2/12

(52) U.S. Cl. CPC F16M 13/022; F16B 2/065; F16B 2/12

(57) ABSTRACT

An installation device which permits an adjustable and fixable angular adaptation of an article to a carrier, characterized in that at least one divided installation element is provided, the parts of which each have a section in a region which permits attachment to the article or to a holder attached to the article, and which, at their ends remote from the respective section which confront one another, jointly form a clamping region and are displaceable relative to one another, the clamping region enabling attachment to the carrier.

The present invention relates to an installation device which permits an adjustable and fixable angular adaptation of an article to a carrier.

Such installation devices are known, for example for the attachment of a navigation apparatus to the windscreen of a vehicle so that the driver can position the screen of the apparatus in a position which is favorable for him to consider. For this purpose a carrier for the navigation apparatus is frequently attached by means of a suction pad to the inner side of the windscreen and the navigation apparatus can be set angularly via a stiff universal joint located between the carrier and a holder at the navigation apparatus and is held in the set position by friction in the universal joint.

An attachment of this kind has undoubtedly proven itself, is however not straightforwardly possible in some situations, for example if a heavy lamp is to be secured to a ceiling or if a plurality of installation device points has to be used, for example for the installation of a projector for a head-up display in the vehicle. If, for example, a projector is to be attached in the region of the dashboard to three or four installation points in a recess by means of threaded pins projecting from the dashboard, then attention must be paid to the fact that the accurate alignment of each of the threaded pins, which take place during automated manufacture, can be lead to disturbing angular and coordinate-wise deviations from the intended position. These deviations can arise because of deformations of the carrier—a metallic sub-construction of the dashboard—and of manufacturing tolerances during the attachment of the threaded pins or other bolt-like or bolt-receiving attachment elements. Furthermore, the installation position of the projector in particular its alignment must be accurately set so that the data display is present at the correct position on the windscreen in the viewing field of the driver.

Moreover, an automatic positioning and fixing of the projector should be made possible, which should preferably only take place from above.

The object of the present invention is to provide a suitable installation device and a clamping device which can be used with it, but also elsewhere, with the installation device preferably being relatively flexible during the installation and thus easy to handle but having a relatively high stiffness in the clamped state in comparison to the flexible state. Furthermore, with a plurality of installation points, an at least substantially uniform load distribution and a simple compensation for alignment deviations of the attachment elements should be achieved. Moreover, at least in some embodiments, an automatic installation should be enabled from one direction.

In order to satisfy these objects an installation device is provided in accordance with the invention which is characterized in that at least one divided installation element is provided, the parts of which each have a section in a region which permits attachment to the article or to a holder attached to the article and which, at their ends remote from the respective section which confront one another, jointly form a clamping region and are displaceable relative to one another, the clamping region enabling attachment to the carrier.

Through the sub-division of the installation element into a plurality of parts with ends which mutually confront one another, which are displaceable relative to one another and which jointly form a clamping region which enables an attachment to the carrier, the installation element can be deformed in a gentle S-like manner, whereby the clamping region has an angular position relative to a straight line (or plane if more than two parts are present) between the two sections at which the parts are secured to the article or to a holder of the article. Furthermore, the mutual displaceability of the confronting ends permits a length compensation for the adopted S-shape without allowing the installation element to appear too stiff. If, however the installation element is clamped in the clamping region, which takes place during the clamping to the carrier, then the relative displaceability of the mutually confronting ends of the parts is cancelled, the installation element retains the pronounced S-shape and is relatively stiff or stiffer as a result of the now fixed length. Moreover, the clamping region can be relatively easily tilted and this tilted position is also retained when the multiply divided installation element is clamped. The installation element is also held in this tilted position and considerably larger forces are necessary in order to move the installation element out of the “frozen” position than were necessary prior to clamping. When the multiply divided installation element is divided in two then one can consider it as a type of leaf spring divided in two which is easily deformable but which becomes considerably stiffer when the previously mutually displaceable ends are clamped, whereby the deformed shape provides an angular compensation for the faulty orientations of the attachment elements even if a plurality of installation points are present. The installation device in accordance with the invention thus permits a variable orientation of an article in space, at least within restricted limits.

It is also possible in accordance with the invention to provide an installation device of the initially named kind which includes at least one multiply divided installation element, the parts of which each have a section in one region which permits an attachment to the article, or to a holder attached to the article, and which jointly form a clamping region at their ends remote from the respective section, the clamping region enabling an attachment to the carrier. Thus, a one-armed or multiply armed installation element is present the parts of which are in particular separately made. The parts form a stack which is clamped in the clamping region for the fixation in the desired position. In other words, the free ends of the parts are displaceable at least fractionally relative to one another prior to their clamping. The free ends preferably each have a cutout which at least partly receives a section of the attachment element with a certain clearance.

It is preferable for the installation element to be divided in two, i.e. to be made with two arms. This is completely adequate and indeed preferred if a plurality of installation devices are used simultaneously because each installation device can be accommodated in a space-saving manner.

A multiply divided form in which the installation element is divided into three or four, i.e. has three or four arms, can however be expedient, for example when an article is to be fixed in its orientation using only one installation device.

Preferably a plurality of divided installation elements of the same design are provided which are placed aligned above one another and form an installation pack. Through the multi-layered design the installation pack remains relatively flexible when fixing the orientation but becomes stiffer as the number of installation elements is increased. The reason for this is that the stiffness of the installation pack in the clamped state rises with the fourth power of the thickness of the installation pack.

It is in particular favorable when the parts of the or each installation element are made the same. In this way only one shape of each part need to be manufactured.

The parts of the or each installation element are preferably formed as punched sheet metal parts or as plastic parts, optionally with fiber reinforcement, these are cost-favorable manufacturing possibilities for mass production.

The sections of the or each installation element are preferably formed by sections which are for example formed with attachment holes. In this way, not only is a cost-favorable manufacture possible, using a punching process or an injection molding process, but rather also a simple the attachment to the article in an accurate position to a holder mounted on the article is possible by means of threaded bolts or rivets. This is however not essential, the said sections could be clamped simply to the article by means of a clamping device or simply plugged into shape-matched recesses at the article.

It is particularly favorable when the ends of the or each installation element which are remote from the respective section and which confront one another, which are displaced relative to one another and which jointly form the clamping region each have cutouts which jointly form an opening for the reception of a fastener element. This enables a simple clamping by attachment elements which extend through the opening.

An installation device is preferred in which the or each part of an installation element has a tongue in the region of the cutout which passes sideways past the attachment element i.e. the opening and in which, with a division of the installation element into two, the identically formed parts are placed turned relative to one another so that their tongues surround the attachment element on both sides. This also has the advantage that, on providing a plurality of installation elements, these can each be placed on one another respectively turned through 180 degrees about their longitudinal axis. Through the clamping of the installation pack the parts of the individual installation elements are so secured by mutual friction and by the attachment element that extends through the openings that lateral deviations are suppressed which is favorable for the reliability of the installation device.

The ends of the or each installation element which are remote from the respective section, which confront one another and which are mutually displaceable can have a small spacing from one another, or can abut one another, or can partly overlap one another in the unattached state.

It is particularly favorable when a spring element is provided at least on the one side of the installation element or the installation pack which covers the sections at least partly and has at least one spring region between them in the plane of the installation element. The spring element is easily extendable in the longitudinal direction as a result of the spring region and is also flexible in torsion. It does not therefore hinder the deformation of the parts of the installation element or the installation pack. The resilient region does however prevent a mutual rotation of the ends of the spring element which cover the sections, so that these ends of the spring element adopt the function of the washer without impairing the function of the installation device and without loose washers being present which could easily disturb the installation sequence.

It is particularly favorable when the spring element has a region which at least partly overlaps the clamping region. This region is then also clamped which further improves the ability to handle the installation device and the rotational security of the ends which form the washers.

The spring element is preferably provided twice and the second spring element is arranged at the other side of the installation element or the installation pack. This leads to a symmetrical design of the installation device so that the orientation or installation is unimportant. Moreover, with plastic parts, an orderly force distribution is ensured at the clamped sections and at the clamping region.

The or each spring region can have a snake-like or meandering shape. A shape of this kind can easily be manufactured in an element which lies in one plane by a punching process or by an injection molding process and can easily be extended in length, whereby adaptation to the S-shape or to the twisted shape of the installation device can be achieved.

As indicated above the or each spring element can be formed at a favorable cost as a punched sheet metal part or as a plastic part, optionally with fiber reinforcement.

The installation device preferably also includes a clamping device which acts in a clamping manner at the clamping region and can be attached by means of a fastener element to the carrier in a vertically adjustable manner and/or with an adjustable spacing.

A particularly preferred clamping device, in particular for use with an installation device as described above, is characterized in that by the following features:
by a first component having an internal thread with a side which forms a first clamping surface either directly or indirectly via a separate part,
by a second component having an internal thread and an external thread which is axially displaceable but rotationally fixedly attachable to the first component, with the respective internal threads of the first component and of the second component being designed so they can jointly be attached in a vertically adjustable manner to a carrier by means of a bolt element with an external thread, and
by a counter nut which can be screwed on the axial thread of the second component and which forms a second clamping surface at its side facing the first clamping surface, either directly or indirectly via a second part, with the first and second confronting clamping surfaces being designed for the clamping reception of an article or of the clamping region of the installation device.

A clamping device of this kind can be easily screwed from above onto a stud or threaded pin or onto a riveted bolt or pierce and rivet bolt or onto a press-in bolt or to a welded bolt, for example from above. The mutual axial displaceability of the first component and of the second component ensures the thread of the stud or of another type of bolt can straightforwardly pass through both components because the longitudinal compensation ensures a continuous thread groove despite the rotationally fixed arrangement. The rotatability of the total structure on the stud or the like, enables an accurate positioning of the height of the one clamping surface relative to the carrier. By rotating the counter nut, the other clamping surface can be moved in a direction of the first said clamping surface and the installation device can be clamped between the clamping surfaces, without the previously set position of the first said clamping surface which brings about the vertical compensation being disturbed.

It will be understood that the internal thread of the first component and the internal thread of the second component must have the same size and pitch so that they can be jointly moved along a threaded region of a threaded bolt.

As the installation unit is flexible in the non-clamped state it can automatically and easily adopt the above-mentioned S-shape matching the faulty orientation of the stud or the like, such as a possibly tilted position of the clamping region in a transverse plane, with the clamping region lying over its full area on the first said clamping surface. In this way the clamping surface formed by the counter nut is guided parallel to the first named clamping surface so that this clamping surface also fully comes into contact at the clamping region. On fastening the counter nut, the second component is first removed by a minimal amount away from the first component as a result of the axial displaceability between the first component and the second component, whereby the counter nut develops its countering function and fixedly clamps the clamping region between the two clamping surfaces and the installation device is automatically “frozen” into the selected aligned position. The installation device is now converted from a flexible structure into a stiff structure with also a certain damping action also being present.

It is particularly favorable when the first component and the second component is secured by means of a connection, in particular an easily releasable connection such as, for example, a click connection or by a rather more permanent connection, such as a beaded-over collar at the one component which engages behind an abutment of the other component while retaining the relative axial displaceability. In this way the first component and the second component form a unit which is easier to handle than two separate individual parts. Moreover, the counter nut is screwed onto the axial thread of the second component and can optionally be prefixed with a weak thread locking compound so that the total structure which is divided into three can be handled and transported as a preassembled unit.

It is also particularly favorable when the second component has a tool mount for the releasable attachment of a rotary tool in particular in the region of the end remote from the first component, with the tool mount of the second component preferably being made smaller in its transverse dimensions than the counter nut. In this way the second component and the counter nut can be jointly rotated with different coaxially arranged tools or be rotated relative to one another and also operated from one side of the construction.

As a result the above-named total unit can be secured by means of the tool mount to the second component, for example from above, onto the threaded pin and the counter nut can be tightened in the same working process.

The tool mount of the second component is preferably formed by an internal socket which is preferably provided in the end face of the second component remote from the first component. In this way the second component can have a shape which is relatively simple, which saves space and which is easily manufactured and can be produced in the manner of a hollow grub screw with an internal thread or as a sleeve with internal and external threads.

The first component can likewise be provided with a tool mount, in particular in the form of an external polygon. This can be of advantage when the clamping device is to be installed manually on the threaded pin or the like or when the position of an automatically preinstalled clamping device is to be corrected.

It is advantageous when the first component is provided with a flange the end face of which confronting the second component directly forms the first clamping surface, or which acts on a washer which forms the first clamping surface. A flange of this kind or a washer of this kind increases the size of the clamping surface in a cost-favorable manner.

For the same reason the counter nut can be provided with a flange, the end face of which confronting the first component either directly forms the second clamping surface or acts on a washer which forms the second clamping surface.

The clamping device in accordance with the invention is preferably so used that the external thread of the second component extends through a cutout in the clamping region of the installation device with the installation device being able to be clamped between the first component and the counter nut screwed onto the second component. This is indeed probably the best arrangement but is however not compulsory.

As an alternative to this the first component could either be provided with a laterally arranged lug the side of which confronting the second component forms the first clamping surface or acts on a washer which is provided with a laterally arranged lug the side of which confronting the second component forms the first clamping surface. For this purpose, the first clamping surface is arranged laterally offset to the central longitudinal axis of the threaded pin.

In just the same way the counter nut could either be provided with a laterally arranged lug the side of which facing the first component directly forms the second clamping surface or can engage on a washer which is provided with a laterally arranged lug the side of which confronting the second component forms the second clamping surface.

The laterally offset arrangement of the first clamping surface and of the second clamping surface thus forms a type of U-shaped clamping recess in which for example the clamping region of the installation device can be clamped. The clamping device then extend laterally past the installation device other than the parts which form the clamping surfaces.

The installation device in accordance with the invention and the clamping device in accordance with the invention will now be explained in more detail in the following by way of exemplary embodiments and with reference to the drawings, in which are shown:

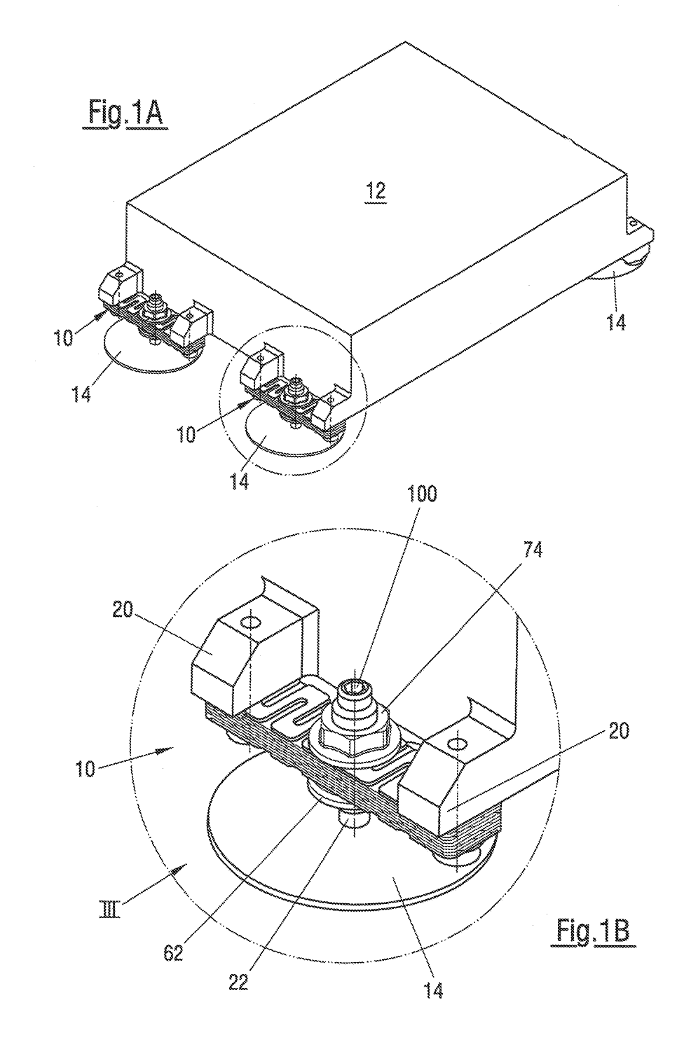

FIG. 1A a perspective illustration of a projector of a head-up display which is provided at four points with installation devices,

FIG. 1B an enlarged perspective detail of the installation device of FIG. 1A shown in the circle,

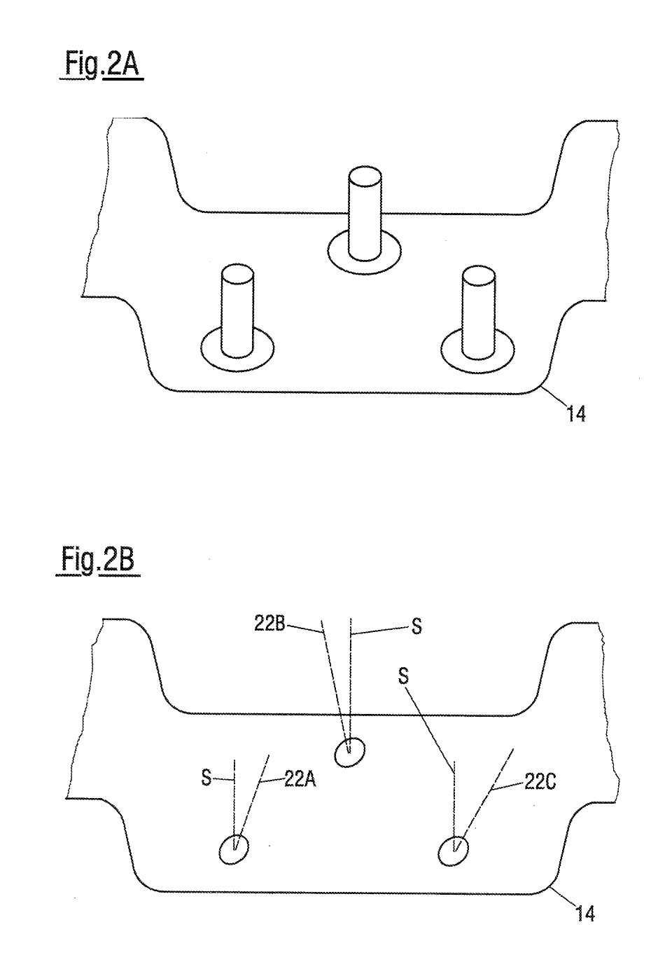

FIG. 2A a perspective representation of a preferred installation location for a projector similar to the projector of FIG. 1A but with three installation points instead of four,

FIG. 2B an illustration similar to FIG. 2A but in which the faulty orientations and positions of the threaded pins provided for the installation are indicated,

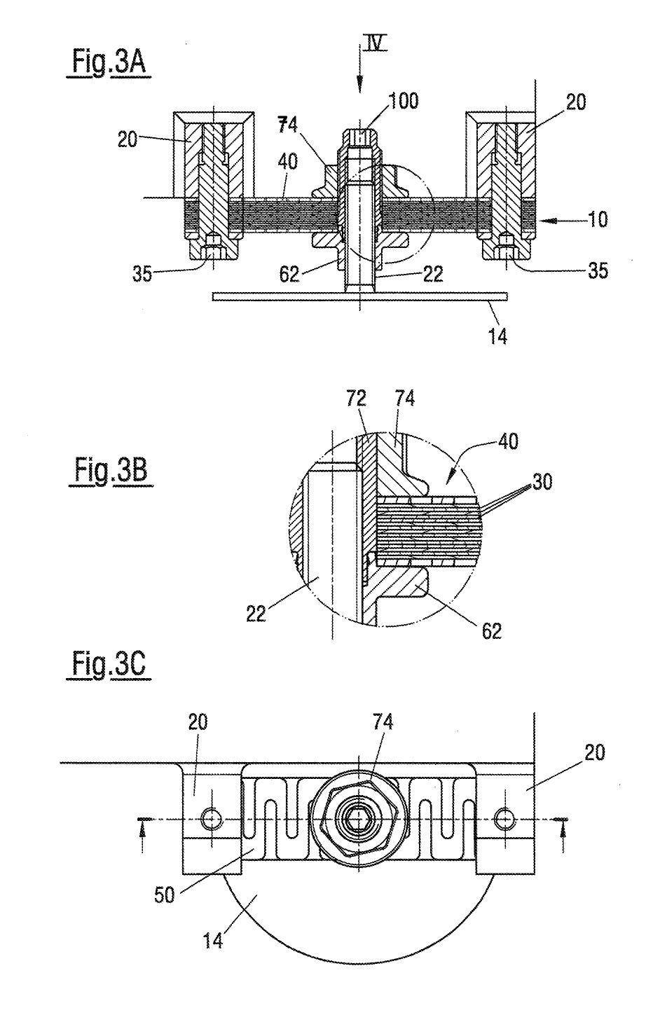

FIG. 3A a sideview of the installation device of FIG. 1B seen in the direction of the arrow III,

FIG. 3B an enlarged representation of the encircled region of FIG. 3A,

FIG. 3C a plan view of the installation device of FIG. 3A seen in the direction of the arrow IV,

FIG. 3D an illustration similar to FIG. 3A but of the installation device in a form bent in an S-shaped manner,

FIG. 3E a representation similar to FIG. 1B but of the installation device in a position tilted in a transverse plane,

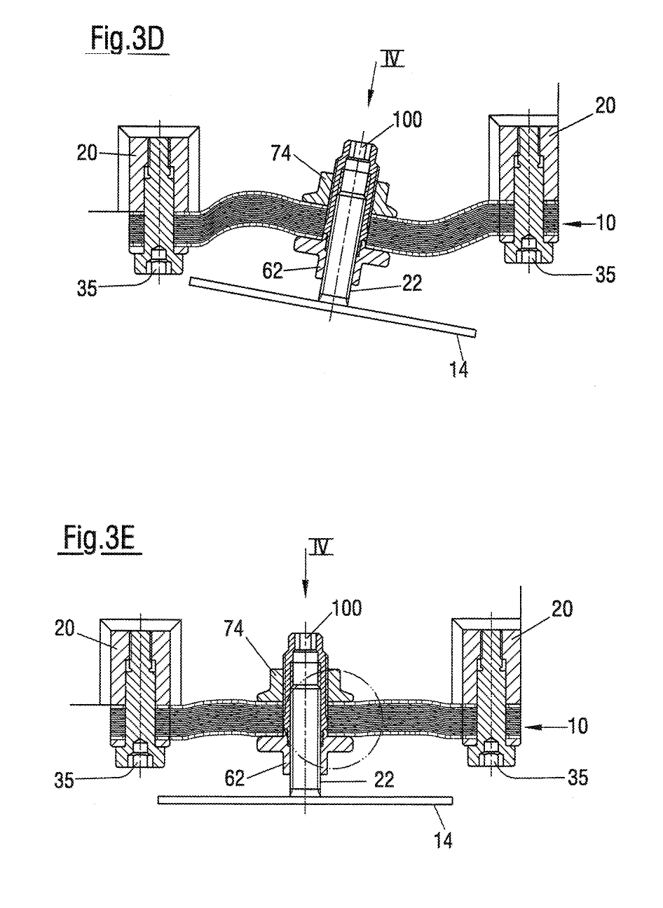

FIG. 4A-E a plan view (FIG. 4A), a sideview (FIG. 4B) and a perspective view (FIG. 4C) of an installation element in accordance with the invention, with FIG. 4D corresponding to the view of FIG. 4B but showing the installation element in the bent S-shape corresponding to FIG. 3D and FIG. 4E likewise corresponding to the view of FIG. 4B but with the clamping region of the installation element tilted in accordance with the illustration of FIG. 3E,

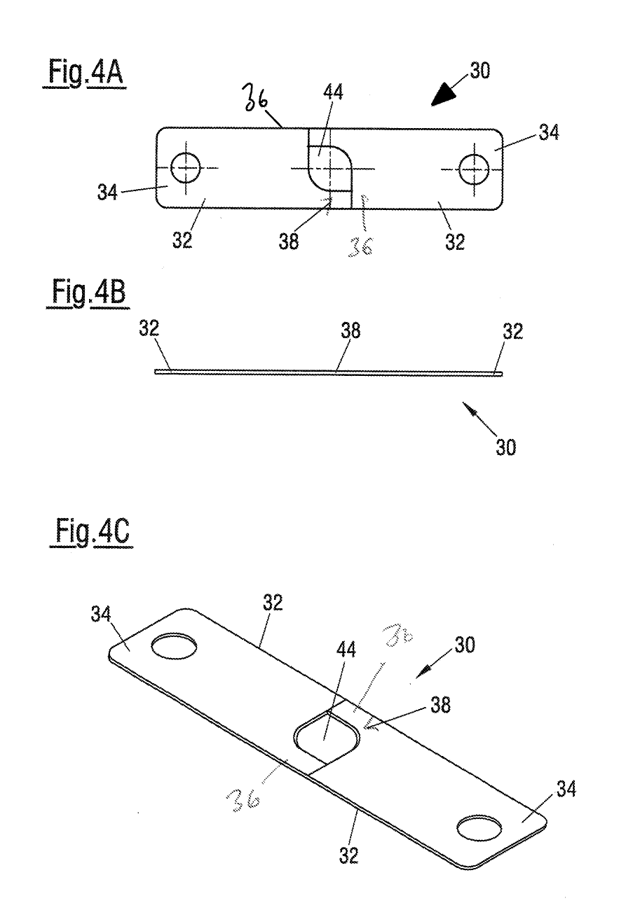

FIGS. 5A-C a plan view, a sideview and a perspective view of a spring element in accordance with the invention,

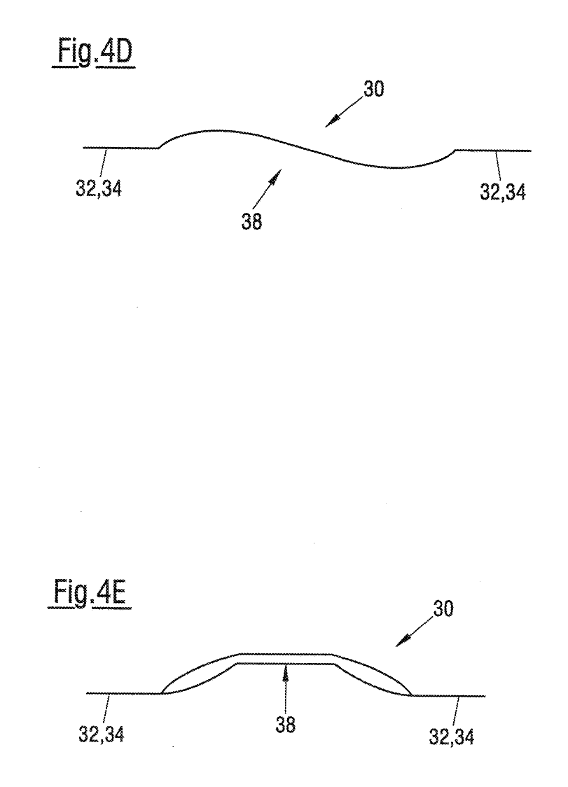

FIG. 6 a plan view of a three-armed installation element in accordance with the invention,

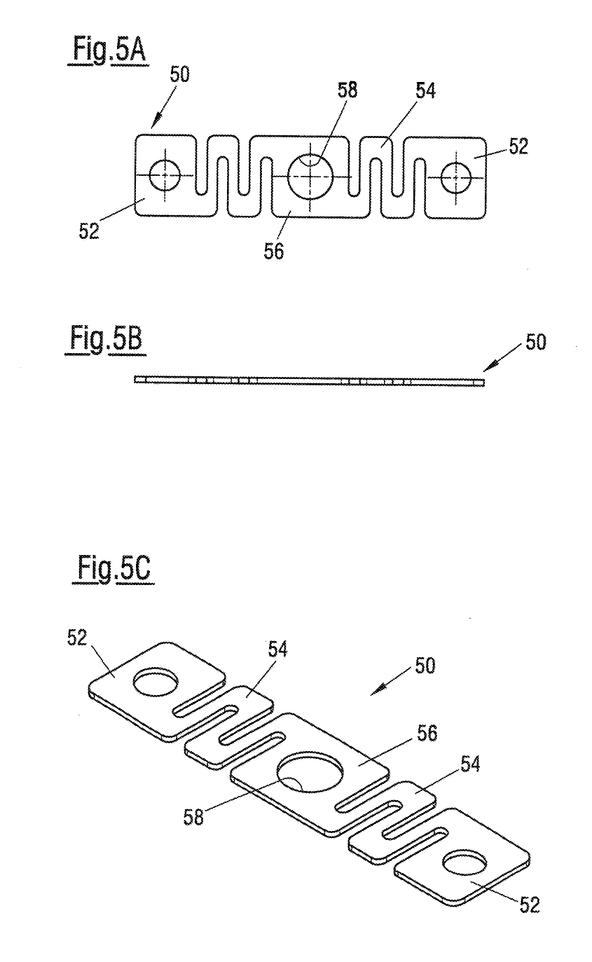

FIG. 7 a plan view of a four-armed installation element in accordance with the invention,

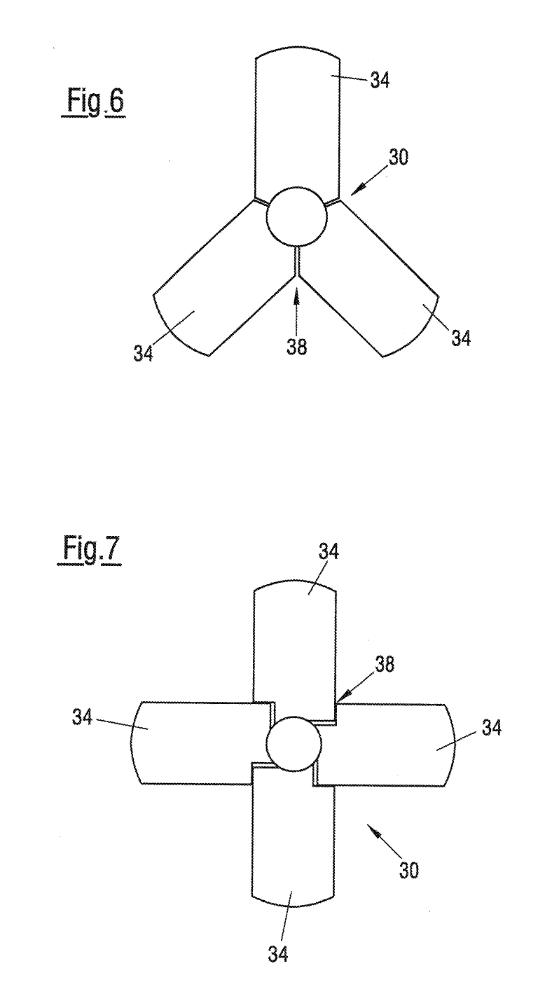

FIGS. 8A-C a perspective illustration of a clamping device in accordance with the invention which can be used with the installation device in accordance with the invention and in accordance with previous Figures, a representation of the clamping device of FIG. 8B sectioned in the longitudinal direction and an enlarged representation of the encircled region of the illustration in accordance with FIG. 8B,

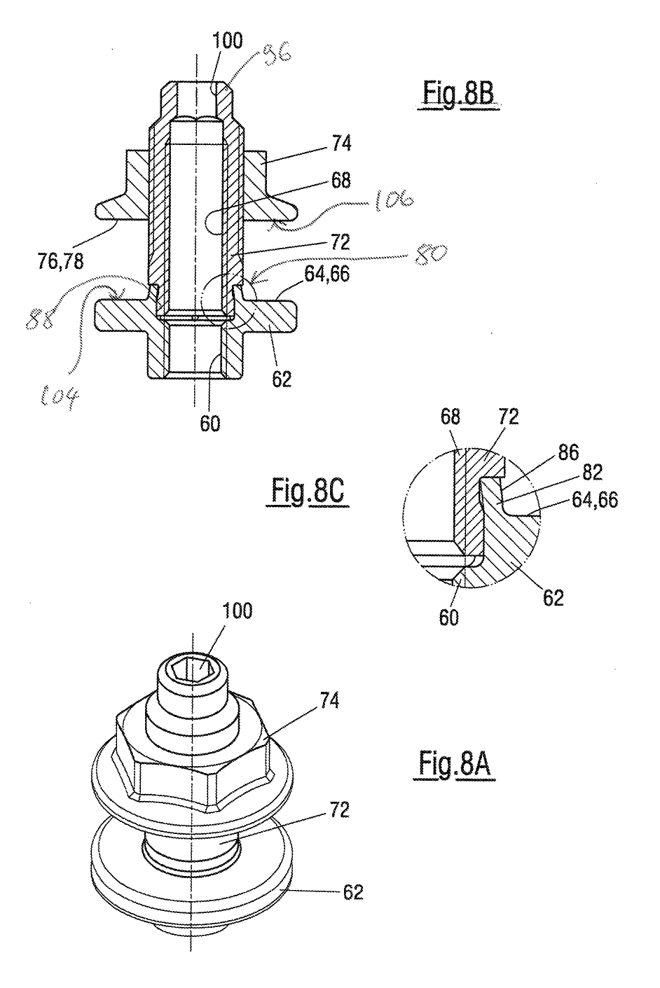

FIGS. 9A-F the first component of the clamping device of the invention of FIG. 8A to C in a view from above, in a sectioned view in a longitudinal plane, in a sideview, in an enlarged perspective view of an inner region provided with longitudinal ribs, in a perspective view from below and in a perspective view from above,

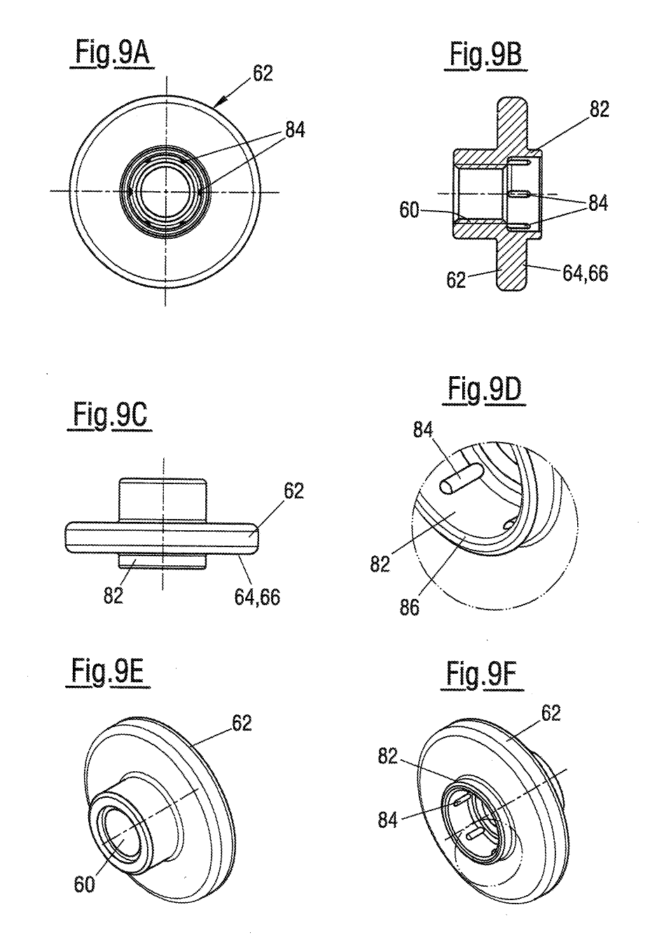

FIGS. 10A-F the second component of the clamping device of FIG. 8A to C in a view from above, in a view sectioned in a longitudinal plane, in a sideview, in an enlarged perspective view of an inner region provided with longitudinal ribs, in a perspective view from below and in a perspective view from above,

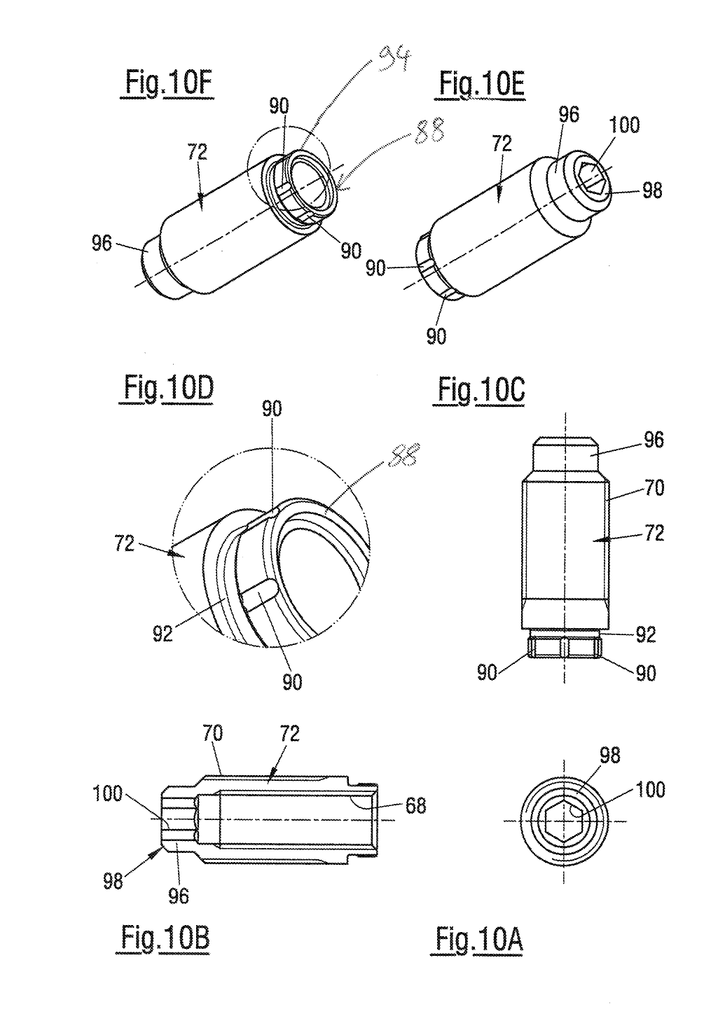

FIG. 11 a perspective illustration similar to FIG. 8A in which however the first component is provided with a lateral lug which forms the first clamping surface and the counter nut acts on a separate washer with a lateral lug which forms the second clamping surface, and

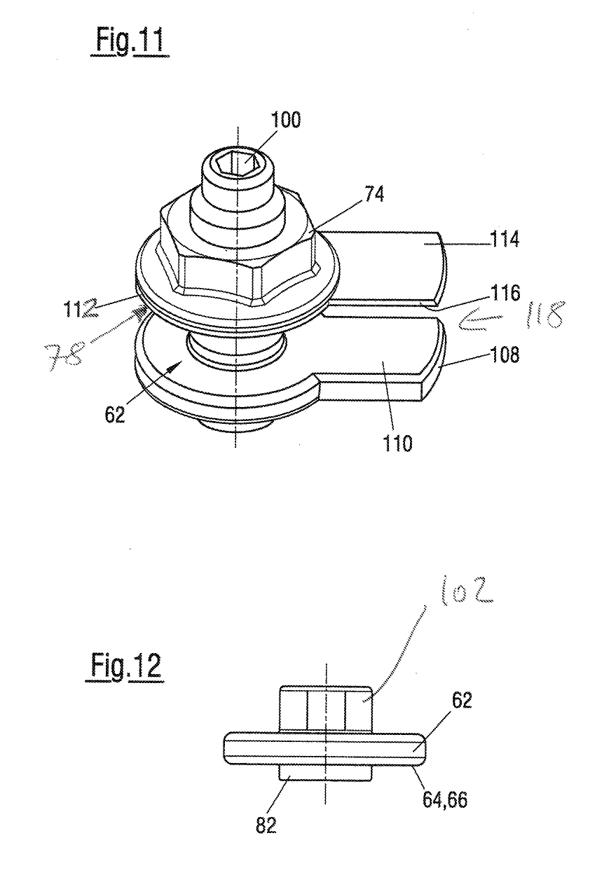

FIG. 12 a representation similar to FIG. 9C but with an alternative design of a first component with a hexagonal mount for a tool.

In FIGS. 1A and 1B three installation devices 10 in accordance with the invention are shown which permit an adjustable and fixable angular adaptation of an article 12, here in form of a projector for the head-up display, to a carrier 14. In the specific embodiment four installation devices 10 are present of which two are provided at the front side and two at the rear side of the parallelepiped shaped projector 2 adjacent to its vertical edges 16, with the one installation device at the rear side not being visible in the representation. Specifically, each installation device is secured at its ends by means of threaded bolts 35 (FIGS. 3A to 3E) to corresponding holders 20 of the projector. The carrier 14 is indicated here only by circles is however in this specific example normally formed by a sheet metal structure of a motor vehicle dashboard of which a section is shown in more detail in schematic form in FIG. 2A. However, in the example of FIG. 3A only three installation points for the projector 12 are used, here in the form of elongate pierce and rivet bolts 22 which are riveted to the sheet metal part. By way of example SBF pierced and rivet bolts of the applicants can be used which are riveted at their head part 24 to the sheet metal part. The shaft parts 22 of the pierce and rivet bolts which have upwardly directed threads respectively pass through a clamping device 28 at the center of each installation device as is shown in FIGS. 1A and 1B.

FIG. 2B shows that the shaft parts 22 of the pierce and rivet bolts which will simply be called threaded pins in the following, can have faulty orientations and position errors which need to be compensated, which is possible with the installation devices 10 in accordance with the invention as will later be explained in more detail.

From FIG. 2B it is evident that the threaded pins 22A and 22B have angular deviations from the desired position which is shown by a broken line and the third threaded pin 22C is laterally displaced from the desired position.

The specific design of the installation device 10 will now be explained in more detail with reference to the further FIGS. 3A to 3E, 4A to 4E and 5A to 5C.

The installation device 10 includes at least one divided installation element 30 in accordance with FIG. 4A to C of which the two separate parts 32 each have a section in the one end region 34 which enables an attachment to the article 12 directly or to a respective holder attached to the article. At their ends 36 remote from the respective section, which confront one another and are displaceable relative to one another, the parts 36 jointly form a clamping region 38 which enables an attachment to the carrier 14.

The two-part installation element 30 shown here can be said to be two-armed. Basically, a one-armed embodiment is also possible. The corresponding multi-layered installation element would then look as something like is shown in FIG. 3A, but then only one holder 20 corresponding only to approximately one half of the installation device 10 shown in FIG. 3A are present. Speaking in terms of pictures one can consider the installation device in this embodiment at least as a quarterelliptic leaf spring for a rear axle of a vehicle, wherein the installation device becomes adequately stiff by clamping the two ends of the layers. However, three part or four part embodiments are also conceivable which are then termed three-armed or four-armed. Examples for such three- or four-armed installation elements are shown in FIGS. 6 and 7 and the description given here also applies in the same sense to the embodiments of FIGS. 6 and 7 in which the corresponding reference numerals are entered to extent that this is meaningful.

As shown in FIGS. 3A to 3C a plurality of divided, normally identically made, installation elements 30 are used in one installation device 10. They are laid on top of one another in an aligned manner and form an installation pack 40.

The parts 32 of the or each installation element 30 are made the same and are formed as sheet metal parts or as plastic parts, optionally with fiber reinforcement.

The sections at the ends 34 of the parts 32, which serve for the attachment to the article or to the holders of the article, normally have cutouts which are for exampled formed as attachment holes. They are attached to the holders 20 by means of attachment bolts 35.

The mutually confronting ends 36 of the parts 32 are displaceable relative to one another. In the aligned position in accordance with FIGS. 3A to 3C they can touch each other or can have a small distance from one another. On deformation of the installation elements, as shown in FIG. 3D or 3E they move somewhat apart. The parts can also mutually overlap at their ends 36. In this case the degree of the overlap on deformation of the installation element becomes smaller. In the embodiments shown the confronting ends 36 of the parts 32 which form the clamping region 38 have respective cutouts 42 which jointly form an opening 44 to receive a clamping device 28 (FIG. 1B).

As shown in FIGS. 3A to 3C each of the parts 32 of the installation element 30 forms a tongue in the region of the cutout 42 which extends laterally past the attachment element. With the shown two-part division of the installation element 10 the identically formed parts 32 are placed inversely to one another so that their tongues 46 frame the clamping device 28 at both sides. With the provision of plurality of installation elements these are respectively placed on one another rotated to 180 degrees about their longitudinal axis 48 which enhances the stability of the installation device.

It is preferred when a spring element 50 is placed at least on one side of the installation element 10 or the installation pack 40 which at least partly covers over the attachment section at the ends 34 by an areal region 52 and has between them at least one spring region 54 in the plane of the installation element 30, here two spring regions 54 are shown. The or each spring region has a snake-like or meandering form. Furthermore, the spring element 50 preferably has a central region 56 which at least partly overlaps the clamping region 38 and has an opening 58 which corresponds to the opening 44.

In the examples shown the spring element 50 is provided twice, with the spring elements being arranged one above the installation pack 40 and one below the installation pack 40. The spring element or each spring element can also be formed as a punched sheet metal part or as a plastic part, optionally with fiber reinforcement.

As already indicated each installation device also has a clamping device 28 which acts clampingly on the clamping region and can be attached in vertically adjustable manner or with an adjustable spacing to the carrier 14 by means of a threaded pin 22.

Specifically, the clamping device 28 in accordance with FIG. 8A to C has the following components:
A first component 62 having an internal thread 60 with a side 64 which forms a first clamping surface 66 either directly or indirectly via a separate part.
A second component 72 having an internal thread 68 and an external thread 70 which is actually displaceable but rotationally fixedly attached to the first component 62, with the respective internal threads 60, 68 of the first component 62 and of the second component 72 being designed so that they can be axially adjustably jointly secured to the carrier 14 by means of a pin element 22 with an external thread.
A counter nut 74 which is screwed onto the external thread 70 of the second component 72, with the side 76 of the counter nut facing the first said clamping surface 66 forming a second clamping surface 78.

The first and second mutually confronting surfaces 66, 78 are designed for the clamping reception of the clamping region 38 of the installation device 10.

The clamping device 28 can also be used for entirely different clamping purposes. In this case the article to be clamped is arranged between the clamping surfaces 66, 78.

The first component 62 is connected to the second component 72 by a releasable connection 80, in particular an easily releasable connection 80 which allows the relative axial displaceability to be maintained, in this embodiment by a click connection the details of which can best be seen from the FIG. 9A to F and 10A to F.

The upper end of the first component is formed as a hollow cylinder 82 with longitudinal ribs 84 at the inner surface of the hollow cylinder, with a ring region 86 above the ribs being inclined slightly inwardly (best evident at 86 in FIG. 8C). The lower end 88 of the second component 72 is of smaller diameter than its external thread 70 and has internal longitudinal grooves 90 in which the longitudinal ribs 84 of the first component are slidingly received, whereby the mutual axial displaceability of the two components 62, 72 is ensured while retaining a rotationally fixed arrangement. In this connection the radially inwardly directed ring region 86 at the free end of the hollow cylinder 82 engages into a ring groove 92 behind the longitudinal grooves 90 of the second component 72. The cylindrical region 94 at the upper end of the second component thus engages in the hollow cylinder 82 of the first component 62. The two components 62 and 72 are thus secured together but are still axially displaceable relative to one another, with the extent of the axial displacement not having to be more than the axial length of one thread turn. The extent of the axial displacement can be determined by the width of the ring groove 92.

Instead of a click connection a permanent connection can also be achieved while retaining the relative axial displaceability if for example the ring region 86 is pressed more deeply into the ring groove 92 in the manner of a rivet bead.

The second component 72 has a tool mount 98 in the region of its upper end 96 remote from the first component for the releasable attachment of a rotatable tool. The tool mount 98 of the second component is made smaller in its transverse dimensions than the counter nut 74 so that the second component 72 and the counter nut 74 can be turned jointly or relative to one another using different coaxially arranged tools.

The tool mount 98 of the second component is most simply formed by an internal mount 100 in the manner of a socket head cap screw or a Torx recess which is preferably provided in the end of the second component remote from the first component.

The first component can likewise be provided with a tool mount 102, which can be formed in particular in the form of an outer polygon such as an outer hexagon as is shown in FIG. 12. This tool mount 102 can be of advantage, for example when the clamping device 28 is actuated by hand. Should a tool mount such as 102 be provided at the first component 62 then a tool mount such as 98 at the second component 72 could be dispensed with.

In the example of FIG. 8A to C the first component is provided with an integrated flange 104 the end face of which confronting the second component directly forms first clamping surface. In the same manner the counter nut 74 can be provided with an integrated flange 106 the end face of which confronting the first component 62 directly forms the second clamping surface 78. As an alternative to this the counter nut 74 could, as shown in FIG. 11, engaged on a separate washer 112 which directly forms the second clamping surface 78.

One can see from FIG. 3A to C that a region of the external thread 70 of the secand component 72 and the region of the transition from the first component 62 into the second component 72 extend through the opening 44 of the installation device 10. In other words, the external thread 70 of the second component extends through the cutout in the clamping region 38 of the installation device 10, with the installation device being capable of being clamped between the first component 62 and the counter nut 74 screwed onto the second component 72.

The mutual axial displaceability of the first component 62 and of the second component 72 ensures that the thread of the stud 22 can straightforwardly pass through both components because the length compensation ensures a continuous thread groove despite the rotationally fixed arrangement. The rotatability of the clamping device as a unit on the stud 22 enables a precise positioning of the height of the one clamping surface 66 relative to the carrier 14. By turning the counter nut the other clamping surface 78 can then be moved in a direction towards the first clamping surface 66 and the installation device 10 clamped between the clamping surfaces 66 and 78, without the previously set position of the first said clamping surface 66, which ensures the vertical compensation, being disturbed. Since the installation unit 10 is flexible in a non-clamped state it can automatically adopt the S-form in accordance with FIG. 3D matching the faulty orientation of the stud 22 or the like automatically and easily as well as any tilted position of the clamping region in a transverse plane in accordance with FIG. 3E which lies with its full area on the first clamping surface 66. In this connection the clamping surface 78 formed by the counter nut 74 is guided parallel to the first clamping surface 66 so that this clamping surface 78 also comes into full area contact at the clamping region. On tightening the counter nut 74 the second component 72 is first removed minimally from the first component 72 as a result of the restricted axial displaceability between the first component 72 and the second component 72 with the counter nut 74 then unfolding its countering function and fixedly clamping the clamping region between the two clamping surfaces 66, 68. In this way the installation device is automatically “frozen” in the selected aligned position. The installation device has now been converted from a flexible structure into a stiffer structure, even though a certain damping action is still present.

As shown in FIG. 12 the clamping region of the clamping device can be displaced sideways from the central longitudinal axis. For this purpose, the first component is either provided with a laterally disposed lug 108, the side 110 of which confronting the second component 72 directly forms the clamping surface 66. The counter nut 74 then presses against a separate washer 112 which likewise has a laterally arranged lug 114 the side 116 of which confronts the first component 62 and forms the second clamping surface 78. The second clamping surface 78 and the first clamping surface 66 jointly form a U-shaped clamping recess 118.

Between the laterally disposed first clamping surface 66 of the clamping device 28 and the laterally arranged second clamping surface 78 of the clamping device 28 a U-shaped clamping mount is formed which, in the manner of a vice, can receive an article in a clamping manner, in this case the clamping region of the installation device 10.

The components of the clamping device are preferably all formed of metal, could however alternatively consist, some or all of them, of fiber reinforced plastic. When they are of metal then they are reasonably manufactured in the same way as fastener elements, generally as cold headed parts.

The assembly of the complete installation device can take place in different ways.

It is for example possible to secure the installation pack 40 of only the two parts of the single installation element 30 with or without the spring element 40 or both spring elements 50, if such spring element is provided at all, to the holders 20 of the article by means of attachment screws 35 which are introduced through the attachment holes which form the cutouts at the ends 34 of the parts 32 of each installation element. When a spring element 50 is provided the attachment bolts are also guided through the corresponding holes at the ends of the spring element. If only spring element 50 is used then this is normally placed beneath the heads of the attachment screws 35. If two spring elements are provided it is unimportant which of them lies at the top or at the bottom.

Next of all the clamping device 28 is installed. This can take place in such a way that the first component 62 is joined by means of the described click connection coming from the bottom with the lower end of the second component coming from above which is passed through the opening 44. The counter nut can previously have been screwed onto the second component or can only now be screwed into place, but not yet tightened. The article within the installed installation devices 10 is now positioned on the carrier so that each threaded pin 22 is aligned with the associated installation device 10. This can take place manually or automatically. A pronounced introduction cone at the lower end of each first component 62 offers help here. As the counter nuts 74 have not yet been tightened (it is only with one installation device 10) the installation elements 30 or the installation packs 40 are still flexible and adapt automatically to the actual angular position of the threaded pins 22. By rotation of the unit consisting of a first component 62 and a second component 72 this unit is moved along the respective threaded pin 22 until the desired position has been reached. The axial displaceability between the first component 62 and the second component 72 ensures that the thread of the threaded pin 22 can be passed through although these parts are rotationally fixedly connected to one another. Otherwise this would not be possible because the precise start of the two inner threads 60 and 68 with respect to the central longitudinal axis of the first component 62 and the second component 72 cannot be predicted with the customary manufacturing methods and must therefore be compensated.

When the desired position has been reached the counter nut 74 is pulled tight and the second clamping surface 78 comes into engagement with the clamping region 38 of the installation device 10 and the slightly deformed state of the respective installation element 30 or of the respective installation pack 40 is frozen. The installation has taken place.

It is also conceivable that the installation element 30 or the installation pack 40, optionally with one spring element 50 or with two spring elements 52 is assembled prior to the installation of the article 12 or its holders. The counter nut 74 can then be tightened in order to hold the installation device together. In this case the counter nut 74 then has to be loosened again prior to the attachment of the clamping device to the threaded pin 22. As an alternative to this, the attachment bolts 35 which are installed, and which serve for the attachment of the installation device 10 to the article 12 or to the holders 20, could be previously installed at the installation device 10 in order to ensure the holding together of the parts. For example, the attachment bolts 35 can be designed as thread forming or thread cutting bolts which only form or cut a thread in the lowest layer of the respective installation element 40 (depending on the design an installation element 30 or a spring element 50). With the final attachment to the article 12 or to its holders 20 the threads forming the lowest layer are destroyed on turning the fastening bolts 35 further but have already satisfied their purpose of provisionally holding the assembly together.

Other auxiliary means can also satisfy the purpose of the provisionally holding assembly together, for example a shrinkable hose can be used in order to keep the installation unit together.

The prior installation of the attachment bolts 35 also has advantages in automatic assembly. It would be particularly favorable if the attachment bolts 35 are attached coming from above to the article 12 or to its holders 20. Then the entire assembly of an installation unit 10 could take place with an automated device with a corresponding rotary tools coming from above.

In some installation situations the first component and the second component can be interchanged with advantage, for example in such a way that the first component 62 is arranged at the top and the second component 72 at the bottom.

### REFERENCE NUMERAL LIST

10 installation device
12 projector, article
14 carrier
16 vertical edges of article 12
20 holder
22 pierce and rivet bolts, attachment element
24 head part of the pierce and rivet bolt 22
26 shaft part from the pierce and rivet bolt, threaded pin
28 clamping device
30 installation element
32 part of the installation element 30
34 end region of the part 32, section
35 attachment bolt
36 other end of part 32
38 clamping region of the installation element 30
40 installation pack
42 cutout at the ends 36 of the parts 32, attachment hole
44 opening
46 tongue
48 longitudinal direction of the installation element 30
50 spring element
52 areal region of the spring element 50
54 spring region of the spring element 50
56 central region of the spring element 50
58 opening of the spring element 50
60 internal thread of the first component 62
62 first component
64 side of first component 62
66 clamping surface
68 internal thread of second component 72
70 outer thread of second component 72
72 second component
74 counter nut
76 side of the counter nut
78 second clamping surface
80 connection between the first component 62 and the second component 72
82 hollow cylinder of the upper end of the first component 62
84 longitudinal ribs
86 ring region at the end of the hollow cylinder 82
88 lower end of the second component 72
90 internal longitudinal grooves at the cylindrical end of the second component 72
92 ring groove
94 cylindrical region at the lower end of the second component 72
96 upper end of the second component 72
98 tool mount
100 internal mount
102 tool mount at the first component 62
104 flange of the first component 62
106 flange of the counter nut 74
108 flange of the first component 62
110 side of lug 108
112 separate washer
114 lug of the washer 112
116 side of separate washer 112
118 clamping recess

1. An installation device which permits an adjustable and fixable angular adaptation of an article to a carrier, the installation device comprising at least one divided installation element having parts, the parts each having a section in a region with said section permitting an attachment to the article or to a holder attached to the article and the parts each having an end remote from the respective section, with the respective ends remote from the respective section confronting one another, jointly forming a clamping region and being displaceable relative to one another, the clamping region enabling attachment to the carrier.

2. The installation device in accordance with claim 1,
wherein the installation element is divided into two, i.e. has two arms.

3. The installation device in accordance with claim 1,
wherein the installation element is divided into three or four, i.e. has three or four arms.

4. The installation device in accordance with claim 1,
wherein a plurality of divided installation elements of like design are provided which are placed aligned with one another on top of one another and form an installation pack.

5. The installation device in accordance with claim 1,
wherein the parts of the or each installation element are made the same.

6. The installation device in accordance with claim 1,
wherein the parts of the or each installation element are formed as punched sheet metal parts or plastic parts, optionally with fiber reinforcement.

7. The installation device in accordance with claim 1,
wherein the sections of the or each installation element are formed by cutouts.

8. The installation device in accordance with claim 1,
wherein the ends of the or each installation element which are remote from the respective section, which confront one another and which are displaceable relate to one another and jointly form the clamping region have a respective cutout and these cutouts jointly form an opening for receiving an attachment element of a clamping device.

9. The installation device in accordance with claim 5,
wherein the ends of the or each installation element which are remote from the respective section, which confront one another and which are displaceable relate to one another and jointly form the clamping region have a respective cutout and these cutouts jointly form an opening for receiving an attachment element of a clamping device,
wherein each of the parts of the installation element has a tongue in the region of the cutout which passes laterally past the attachment element or the opening and
wherein, when the installation element is divided into two, the identically formed parts are placed relative to one another in a turned-over manner so that their tongues surround the fastening element or the opening at two sides and, with the provision of a plurality of installation elements, these are respectively placed rotated to one another through 180 degrees around their longitudinal axis.

10. The installation device in accordance with claim 1,
wherein the ends of the or each installation element remote from the respective section, which confront one another and are mutually displaceable either have a small spacing from one another in the unclamped state, or abut one another, or partly overlap one another.

11. The installation device in accordance with claim 1,
wherein a spring element is placed on the one side of the installation element of the installation pack which at least partly covers over the sections and has at least one spring region in the plane of the installation element.

12. The installation device in accordance with claim 11,
wherein the spring element has a region which at least partly covers over the clamping region.

13. The installation device in accordance with claim 11,
wherein the spring element is provided twice and the second spring element is arranged on the other side of the installation element or of the installation pack and/or wherein the or each spring region has a snake-like or meandering shape and/or wherein the or each spring element is formed either as a punched sheet metal part or as a plastic part optionally with fiber reinforcement.

14. The installation device in accordance with claim 1,
wherein a clamping device is provided which acts in the clamping manner at the clamping region and is vertically adjustable attachable to the carrier by means of a fastener element.

15. An installation device which permits an adjustable and fixable angular adaptation of an article to a carrier, the installation device comprising at least one multi-layered installation element having parts, the parts each having a section in one region, said section permitting an attachment to the article or to a holder attached to the article and the parts jointly forming a clamping region at respective ends thereof remote from the respective section, the clamping region enabling an attachment to the carrier.

16. The installation device in accordance with claim 15,
wherein a plurality of divided installation elements of like design are provided which are placed aligned with one another on top of one another and form an installation pack.

17. The installation device in accordance with claim 15,
wherein the parts of the or each installation element are made the same.

18. The installation device in accordance with claim 15,
wherein the parts of the or each installation element are formed as punched sheet metal parts or plastic parts, optionally with fiber reinforcement.

19. The installation device in accordance with claim 15,
wherein the sections of the or each installation element are formed by cutouts.

20. The installation device in accordance with claim 15,
wherein the ends of the or each installation element which are remote from the respective section, which confront one another and which are displaceable relate to one another and jointly form the clamping region have a respective cutout and these cutouts jointly form an opening for receiving an attachment element of a clamping device.

21. The installation device in accordance with claim 17,
wherein the ends of the or each installation element which are remote from the respective section, which confront one another and which are displaceable relate to one another and jointly form the clamping region have a respective cutout and these cutouts jointly form an opening for receiving an attachment element of a clamping device,
wherein each of the parts of the installation element has a tongue in the region of the cutout which passes laterally past the attachment element or the opening and
wherein, when the installation element is divided into two, the identically formed parts are placed relative to one another in a turned-over manner so that their tongues surround the fastening element or the opening at two sides and, with the provision of a plurality of installation elements, these are respectively placed rotated to one another through 180 degrees around their longitudinal axis.

22. The installation device in accordance with claim 15,
wherein the ends of the or each installation element remote from the respective section, which confront one another and are mutually displaceable either have a small spacing from one another in the unclamped state, or abut one another, or partly overlap one another.

23. The installation device in accordance with claim 15,
wherein a spring element is placed on the one side of the installation element of the installation pack which at least partly covers over the sections and has at least one spring region in the plane of the installation element.

24. The installation device in accordance with claim 23,
wherein the spring element has a region which at least partly covers over the clamping region, and/or
wherein the spring element is provided twice and the second spring element is arranged on the other side of the installation element or of the installation pack and/or
wherein the or each spring region has a snake-like or meandering shape and/or in that the or each spring element is formed either as a punched sheet metal part or as a plastic part optionally with fiber reinforcement.

25. The installation device in accordance with claim 15,
wherein a clamping device is provided which acts in the clamping manner at the clamping region and is vertically adjustable attachable to the carrier by means of a fastener element.
